(19) United States
(12) Patent Application Publication
(10) Pub. No.: US 2007/0293594 A1
(43) Pub. Date: Dec. 20, 2007

(54) Viscoelastic polyurethane foam and process for its manufacture

(76) Inventors: Ladislau Heisler, Marietta, OH (US); Gregory A. Pickrell, Parkersburg, WV (US); Lee F. Lawler, Bethel, CT (US); Jolene C. Graham, Marietta, OH (US)

Correspondence Address: DILWORTH & BARRESE, LLP, 333 EARLE OVINGTON BLVD., SUITE 702, UNIONDALE, NY, 11553, US

(21) Appl. No.: 11/453,940

(22) Filed: Jun. 15, 2006

(51) Int. Cl. C08J 9/00

(52) U.S. Cl. 521/110; 524/174

(57) ABSTRACT

The present invention provides a viscoelastic polyurethane foam and a process for the manufacture of such foam. The foam-forming composition of the present invention utilizes a cell opener that inhibits or reduces foam shrinkage that is detrimental to viscoelastic polyurethane foam properties.

### BACKGROUND OF THE INVENTION

Viscoelastic polyurethane foam (also known as “dead” foam, “slow recovery” foam, or “high damping” foam) is characterized by slow, gradual recovery from compression. While most of the physical properties of viscoelastic polyurethane foams resemble those of conventional foams, the density gradient of viscoelastic polyurethane foam is much poorer. Suitable applications for viscoelastic polyurethane foam take advantage of its shape conforming, energy attenuating and sound damping characteristics. For example, viscoelastic polyurethane foam can be used in mattresses to reduce pressure points, in athletic padding or helmets as a shock absorber and in automotive interiors for soundproofing. The specific application determines the desired density of the viscoelastic polyurethane foam. Pillows are usually made at the lower end of the density range, anywhere from about 2 to 3 pounds per cubic foot “pcf”, while mattresses are normally made using viscoelastic polyurethane foam in about the 4 to 8 pcf range.

In general, the components of a viscoelastic polyurethane foam-forming composition include one or more polyols, organic diisocyanates such as MDI, TDI (80/20 and/or 65/35 isomeric mixtures) and blends thereof, catalysts, silicone foam stabilizers, blowing agents and cell openers. Cell openers, which may be of the chemical- or physical-acting variety, promote cell wall rupture during the polyurethane foam forming process. Unless the cells are opened, gases trapped therein will contract as the foam cools and can result in shrinkage of the foam.

The inefficient opening of cells is a well known problem associated with the manufacture of viscoelastic polyurethane foams and can result in foams exhibiting excessive shrinkage and loss of performance properties which, consequently, must be scrapped.

A current industry trend is to raise the density of viscoelastic polyurethane foams by employing TDI/MDI mixtures or MDI alone. Higher density foams require lowering the water content (blowing agent) of the foam-forming formulation. This reduction in water content causes less urea formation as a result of which the foam exhibits less permeability (open cell content). To offset this reduction in permeability, large amounts of cell opener have been incorporated in such foam-forming formulations, e.g., greater than 3 parts per hundred parts polyol (hereinafter, “pphp”). However, at such high levels cell openers can have a negative impact on cell structure, in particular, mean cell size tends to increase, and on one or more mechanical properties of the foam such as tensile strength, elongation, tear resistance and compression set.

### SUMMARY OF THE INVENTION

In accordance with the present invention, there are provided a viscoelastic polyurethane foam and a process for the manufacture of such a foam, the viscoelastic polyurethane foam-forming composition comprising:
a) at least one polyether polyol;
b) at least one organic polyisocyanate;
c) at least one catalyst for the polyurethane foam-forming reaction(s);
d) at least one silicone foam stabilizer;
e) at least one cell opener which is a polyalkylene oxide lacking silicone in its structure; and,
f) at least one blowing agent.

The polyalkylene oxide cell openers employed in the manufacture of the viscoelastic polyurethane foam of this invention are effective at low use levels. They are useful across the full range of foam densities, from low to high (e.g., from about 1.5 to about 8 lbs/cu. ft and even higher) and foam formulations containing MDI alone, TDI alone and mixtures of MDI and TDI. The use of polyalkylene oxide cell openers inhibits or reduces foam shrinkage that is detrimental to viscoelastic polyurethane foam properties. Additionally, these cell openers provide a softening effect, yet a further advantage to their use.

The polyalkylene oxide cell openers are used in combination with known and conventional silicone foam stabilizers, the latter providing the requisite foam stability. Used in combination with such cell openers, a higher level of silicone stabilizer can be used resulting in viscoelastic polyurethane foams with improved, finer cell structure. It has also been found that the combined use of the polyalkylene oxide cell openers of the present invention and known and conventional silicone foam stabilizers provides an improved, wider processing latitude for both the cell opener and the foam stabilizer, and widens the currently narrow processing window that is common for prior known cell openers used in the manufacture of viscoelastic polyurethane foams.

### DETAILED DESCRIPTION OF THE INVENTION

Throughout the description of the invention which follows, it will be understood by persons skilled in the art that all numerical values disclosed therein include all subranges therein. Polyether polyol component (a) of the viscoelastic polyurethane foam-forming composition is at least one of the type generally used to prepare viscoelastic polyurethane foams. Specifically, polyether polyol (a) can have an average molecular weight of from about 400 to 4500, advantageously from about 550 to about 2200 and more advantageously from about 900 to about 1350. The expression “polyether polyol” includes linear and branched polyethers (having ether linkages), possessing at least two hydroxyl groups.

Non-limiting examples of suitable polyether polyol (a) are those derived from propylene oxide and/or ethylene oxide and an organic initiator or mixture of initiators. The average number of hydroxyl groups in polyether polyol (a) is achieved by control of the functionality of the initiator or initiator mixture used in producing polyether polyol (a).

To manufacture viscoelastic polyurethane foam, it is often desirable to use so-called “viscoelastic polyol”. Viscoelastic polyol is characterized by high hydroxyl number (OH) and tends to produce shorter chain polyurethane blocks with a glass transition temperature of the resulting foam closer to room temperature. As is well known, the hydroxyl number of a polyol is the number of milligrams of potassium hydroxide required for the complete hydrolysis of the fully acylated derivative prepared from one gram of polyol. The hydroxyl number is also defined by the following equation, which reflects its relationship with the functionality and molecular weight of polyether polyol:

$$OH No . = \frac{56.1 \times 1000 \times f}{M . W .} \qquad ( a )$$

wherein OH=hydroxyl number of polyether polyol (a); f=average functionality, that is, average number of hydroxyl groups per molecule of polyether polyol (a); and M.W.=average molecular weight of polyether polyol (a). In one specific embodiment, polyether polyol (a) can have a functionality of from about 2 to about 6, in a more specific embodiment from about 2.5 to about 4.5, and in a still more specific embodiment from about 2.8 to about 3.5.

Any of the known “viscoelastic polyols” and combinations of such polyols can be used herein including those obtainable from BASF, Bayer AG, Dow, Huntsman to name just some of the commercial sources for these reactants.

Useful polyether polyols (a) include polyoxyalkylene polyols, particularly linear and branched poly(oxyethylene)glycols, poly(oxypropylene)glycol, copolymers of the same such as poly(oxyethylene-oxypropylene)polyether polyols and combinations thereof.

Also useful are graft or modified polyether polyols, i.e., polyether polyols having at least one polymer or copolymer of ethylenically unsaturated monomer dispersed therein. Non-limiting representatives of graft or modified polyether polyols include polyoxypropylene polyether polyol in which is dispersed poly(styrene co-acrylonitrile) or polyurea, and poly(oxyethylene-oxypropylene)polyether polyols in which is dispersed poly(styrene co-acrylonitrile) or polyurea. The solids content of these polyols tend to increase the hardness and mechanical strength of the resulting viscoelastic polyurethane foam.

In one embodiment of the invention, a combination of polyether polyols (a) can be employed. For example, at least one polyether polyol (a) (i) possessing an average molecular weight of from about 600 to about 2000 and a hydroxyl number of from about 120 to about 600 such as U-1000 (polyether polyol having an average molecular weight of about 1000 and a hydroxyl number of 158-178 from Bayer AG) can be combined in widely varying proportions with at least one polyether polyol (a) (ii) which is an aforesaid graft or modified polyether polyol possessing an average molecular weight of from about 2000 to about 4000 and a hydroxyl number of from about 20 to about 120, containing a dispersion of poly(styrene co-acrylonitrile) or polyurea. Especially preferred graft polyols in this invention are Arcol® HS-100 from Bayer AG, Pluracol® 1543 from BASF and Voranol® 3943 from Dow. Modified polyether polyols are commercially available from several companies including Bayer (supplied as “Polymer Polyol” or “PHD Polyol”), BASF (supplied as “Graft Polyol”), and Dow Chemical (supplied as “Co-polymer Polyol). Bayer (“Polymer Polyol”), BASF, and Dow disperse poly(styrene co-acrylonitrile) into the polyol, while Bayer (“PHD Polyol”) disperses polyurea therein. These dispersions are made by polymerizing ethylenically unsaturated monomer(s) in situ.

Specific combinations of polyether polyols (a) can contain from about 50 to about 95 weight percent of first polyether (a) (i) in a first embodiment and from about 65 to about 85 weight percent of this polyol in a second embodiment, the balance of the combined polyols being made up of second polyether polyol (a) (ii).

The invention contemplates the use of organic polyisocyanates heretofore used in the production of viscoelastic polyurethane foams. Such polyisocyanates include, inter alia, MDI, TDI (inclusive of its isomeric mixtures, e.g., one containing from about 60 to about 80 weight percent 2,4-toluene diisocyanate, the balance being the 2,6-isomer). Part or all of the TDI can be replaced with MDI. Thus, e.g., mixtures of TDI and MDI containing from about 60 to about 80 weight percent TDI, the balance being MDI, are suitable for use herein as are foam-formulations containing MDI exclusively.

The amount of polyisocyanate (b) employed is frequently expressed by the term “index” which refers to the ratio of the actual amount of isocyanate used in a given reaction to the stoichiometric amount required to react with all of the active hydrogen-containing material present in the foam-forming composition multiplied by 100. For many foam applications, the isocyanate index will be in the range of from about 70 to about 140. In this invention, the isocyanate index is advantageously below about 100, e.g., is in the range of from about 70 to about 95. Polyisocyanates are typically used at a level of from about 20 to about 90 parts by weight per 100 parts of polyol depending upon the polyol OH content and the water content of the formulation.

Catalyst (c) for the production of the viscoelastic polyurethane foam herein can be a single catalyst or mixture of catalysts such as those commonly used to catalyze the reactions of polyol and water with polyisocyanates to form polyurethane foam. It is common, but not required, to use both an organoamine and an organotin compound for this purpose. Other metal catalysts can be used in place of, or in addition to, organotin compound. Suitable non-limiting examples of viscoelastic polyurethane foam-forming catalysts include (i) tertiary amines such as bis(2,2′-dimethylamino)ethyl ether, trimethylamine, triethylenediamine, triethylamine, N-methylmorpholine, N,N-ethylmorpholine, N,N-dimethylbenzylamine, N,N-dimethylethanolamine, N,N,N′,N′-tetramethyl-1,3-butanediamine, pentamethyldipropylenetriamine, triethanolamine, triethylenediamine, 2-{[2-(2-dimethylaminoethoxy)ethyl]methylamino} ethanol, pyridine oxide, and the like; (ii) strong bases such as alkali and alkaline earth metal hydroxides, alkoxides, phenoxides, and the like; (iii) acidic metal salts of strong acids such as ferric chloride, stannous chloride, antimony trichloride, bismuth nitrate and chloride, and the like; (iv) chelates of various metals such as those which can be obtained from acetylacetone, benzoylacetone, trifluoroacetylacetone, ethyl acetoacetate, salicylaldehyde, cyclopentanone-2-carboxylate, acetylacetoneimine, bis-acetylaceone-alkylenediimines, salicylaldehydeimine, and the like, with various metals such as Be, Mg, Zn, Cd, Pb, Ti, Zr, Sn, As, Bi, Cr, Mo, Mn, Fe, Co, Ni, or such ions as MoO₂++, UO₂++, and the like; (v) alcoholates and phenolates of various metals such as Ti(OR)₄, Sn(OR)₄, Sn(OR)₂, Al(OR)₃, and the like, wherein R is alkyl or aryl of from 1 to about 12 carbon atoms, and reaction products of alcoholates with carboxylic acids, beta-diketones, and 2-(N,N-dialkylamino) alkanols, such as well known chelates of titanium obtained by this or equivalent procedures; (vi) salts of organic acids with a variety of metals such as alkali metals, alkaline earth metals, Al, Sn, Pb, Mn, Co, Bi, and Cu, including, for example, sodium acetate, potassium laurate, calcium hexanoate, stannous acetate, stannous octoate, stannous oleate, lead octoate, metallic driers such as manganese and cobalt naphthenate, and the like; (vii) organometallic derivatives of tetravalent tin, trivalent and pentavalent As, Sb, and Bi, and metal carbonyls of iron and cobalt; and combinations thereof. In one specific embodiment organotin compounds that are dialkyltin salts of carboxylic acids, can include the non-limiting examples of dibutyltin diacetate, dibutyltin dilaureate, dibutyltin maleate, dilauryltin diacetate, dioctyltin diacetate, dibutyltin-bis(4-methylaminobenzoate), dibuytyltindilaurylmercaptide, dibutyltin-bis(6-methylaminocaproate), and the like, and combinations thereof. Similarly, in another specific embodiment there may be used trialkyltin hydroxide, dialkyltin oxide, dialkyltin dialkoxide, or dialkyltin dichloride and combinations thereof. Non-limiting examples of these compounds include trimethyltin hydroxide, tributyltin hydroxide, trioctyltin hydroxide, dibutyltin oxide, dioctyltin oxide, dilauryltin oxide, dibutyltin-bis(isopropoxide) dibutyltin-bis(2-dimethylaminopentylate), dibutyltin dichloride, dioctyltin dichloride, and the like, and combinations thereof.

In one embodiment, catalyst (c) can be an organotin catalyst selected from the group consisting of stannous octoate, dibutyltin dilaurate, dibutyltin diacetate, stannous oleate and combinations thereof. In another embodiment, catalyst (c) can be an organoamine catalyst, for example, tertiary amine such as trimethylamine, triethylamine, triethylenediamine, bis(2,2′-dimethylamino)ethyl ether, N-ethylmorpholine, diethylenetriamine and combinations thereof. In another embodiment, catalyst (c) can include mixtures of tertiary amine and glycol, such as Niax® catalyst C-183 (GE), stannous octoate, such as Niax® catalyst D-19 (GE, and combinations thereof.

Silicone foam stabilizer (d) employed in the viscoelastic polyurethane foam-forming composition herein can be selected from amongst any of the many silicone foam stabilizers, e.g., polysilicone-polyoxyalkylene copolymers, heretofore known for use in the manufacture of polyurethane foams. Specific silicone foam stabilizers (d) that can be used herein include Niax® silicones L-635, L-620 and SC-154, all from GE Advanced Materials, Silicones. These and other useful silicone foam stabilizers possess a polysiloxane backbone and one or more terminal and/or internal polyoxyalkylene (i.e., polyether) moieties.

As is known, silicone foam stabilizers in polyurethane foam-forming compositions lower the bulk surface tension of the foam, promote nucleation of bubbles therein, stabilize its rising cellular structure and emulsify incompatible ingredients. Silicone foam stabilizers (d) can be utilized in amounts of from about 0.2 to 2.0 parts by weight, preferably from about 0.5 to about 1.0 parts by weight, based on 100 parts by weight of polyether polyol.

Polyalkylene oxide cell opener (e), unlike silicone-polyether copolymer used as silicone foam stabilizer (d), contains no silicone component in its structure. Examples of suitable polyalkylene oxides include those possessing an ethylene oxide-based content of from about 65 to about 100 weight percent, an average hydroxyl functionality of from 0 to 3 hydroxyl groups and an average molecular weight (MW) of from about 200 to about 1000. Specific polyalkylene oxide cell openers (e) include those belonging to the following families:
Type 1: Polyethylene glycol monoallyl ether (CAS 27274-31-3), MW 200-1000, 100% EO (ethyleneoxide), 1 OH functionality
Type 2: Polyethylene glycol allyl methyl diether (CAS 27252-80-8), MW 200-1000, 100% EO, 0 OH functionality
Type 3: Polyethylene glycol monoallyl ether acetate (CAS 27252-87-5), MW 200-1000, 100% EO, 0 OH functionality
Type 4: Polyethylene glycol monomethyl ether (CAS 9004-74-4), MW 200-1000, 100% EO, 1 OH functionality
Type 5: Polyethylene glycol glycerol ether (CAS 31694-55-0), MW 200-1000, 100% EO, 3 OH functionality
Type 6: Polyethylene-polypropylene glycol monoallyl ether (CAS 9041-33-2), MW 200-1000, 70-100% EO, 1 OH functionality
Type 7: Polyethylene-polypropylene glycol monoallyl monomethyl diether (CAS 52232-27-6), MW 200-1000, 70-100% EO, 0-0.5 OH functionality
Type 8: Polyethylene-polypropylene glycol allyl ether acetate (CAS 56090-69-8), MW 200-1000, 70-100% EO, 0 OH functionality

Polyalkylene oxide cell opener (e) will be incorporated in the viscoelastic polyurethane foam-forming composition herein in at least a cell opening effective amount. In general, such amounts can vary from as little as about 0.1 pphp to about 4 pphp and advantageously from about 0.2 to about 2 pphp.

The foam-forming formulation herein contains one or more blowing agents (f), e.g., water which will react with polyisocyanate component(s) (b) to generate carbon dioxide in situ. In the case of water as blowing agent (f), from about 0.5 to about 3 weight percent water based on the total weight of polyether polyols (a) can be utilized with generally good results.

Optional components of the viscoelastic polyurethane foam-forming composition herein can include one or more fire retardants, stabilizers, coloring agents, fillers, antimicrobial agents, cross-linking agents, chain extenders, extender oils, anti-static agents, and the like, present in known and conventional amounts.

The viscoelastic polyurethane foam of this invention herein can be formed in accordance with known and conventional processing technology, such as, in particular, the “one shot” technique, the operational requirements of which are well known and need not be recounted here.

### EXAMPLES 1-3

### COMPARATIVE EXAMPLES 1-3

Viscoelastic polyurethane foam-forming compositions were prepared, both within the scope of the invention (Examples 1-3) and illustrative of the prior art (Comparative Examples 1-3), foamed in accordance with known and conventional foaming procedures in the laboratory and the properties of the resulting foams measured as shown below in Table 1.

TABLE 1

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| Viscoelastic Polyurethane | | | | | | |
| Foam-forming Composition | | | | | | |
| Polyether Polyol U-1000 | 80 | 80 | 80 | 80 | 80 | 80 |
| (Bayer AG) | | | | | | |
| Polyether Polyol HS-100 | 20 | 20 | 20 | 20 | 20 | 20 |
| (Bayer AG) | | | | | | |
| Water | 1.4 | 1.6 | 1.4 | 1.4 | 1.6 | 1.4 |
| Niax ® Catalyst C-183 | 0.5 | 0.5 | 0.5 | 0.5 | 0.5 | 0.5 |
| amine catalyst | | | | | | |
| Niax ® Catalyst D-19 | 0.05 | 0.05 | 0.05 | 0.05 | 0.05 | 0.05 |
| stannous octoate catalyst | | | | | | |
| TDI Index | 80 | 80 | | 80 | 80 | |
| TDI 80/20 | 28.2 | 29.8 | | 28.2 | 29.8 | |
| MDI Index | | | 80 | | | 80 |
| Lupranate ® 280 Isocyanate | | | 41.5 | | | 40.8 |
| (MDI) | | | | | | |
| Silicone A (L-635) (General | 0.3 | 0.3 | 0.3 | 0.3 | 0.3 | 0.3 |
| Electric), a foam stabilizer | | | | | | |
| Silicone B (L-626) (General | | | | 0.4 | 0.4 | 0.4 |
| Electric), a known cell | | | | | | |
| opener | | | | | | |
| Type 1 cell opener of the | 2.0 | 3.0 | 2.4 | | | |
| invention | | | | | | |
| Results | | | | | | |
| Rise Time, sec. | 263 | 370 | 292 | 196 | 167 | 232 |
| % Settling | 2.4 | 0.1 | 4.2 | 2.3 | 4 | 0.1 |
| Porosity, cfm | 26 | 157 | 44.9 | 14 | 28 | 9.2 |
| Density, pcf | 3.8 | 3.3 | 4.14 | 3.7 | 3 | 3.8 |
| IFD 25%, lb./50 in² | 10.2 | 7.2 | | 14.2 | 11.9 | |
| IFD 65%, lb./50 in² | 26.9 | 18.8 | | 35.4 | 29.4 | |
| SAG Factor (ratio of IFD | 2.6 | 2.6 | | 2.5 | 2.5 | |
| 65% to IFD 25%) | | | | | | |

As the data in Table 1 show, the generally increased porosities for the foam-forming compositions of Examples 1-3 which employed as a cell opener a polyethylene glycol monoallyl ether of 350 molecular weight in accordance with the invention compared with those of Comparative Examples 1-3 which employed a known silicone-type cell opener is indicative of increased cell opening relative to the latter. The decrease in IFD 25% and IFD 65% (Indentation Force Deflection) for the foam of Example 1 is indicative of a softer foam than that of Comparative Example 1. The SAG factor for the foam obtained from the composition of Example 1, an indicator of the degree of foam support, exhibited an increase over the SAG factor of the foam resulting from the composition of Comparative Example 1

### EXAMPLE 4

### COMPARATIVE EXAMPLE 4

Viscoelastic polyurethane foam-forming compositions were prepared, foamed in a foam manufacturing line operated in accordance with conventional full-scale foam manufacturing conditions and the properties of the resulting foams measured as set forth below in Table 2.

TABLE 2

| | Ex. 4 | Comp. Ex. 4 |
|---|---|---|
| Viscoelastic Polyurethane Foam- | | |
| forming Composition | | |
| Polyol A (Polyol blend having a | 80 | 80 |
| nominal OH No. of 168) | | |
| Polyol B (Polyol blend having a | 20 | 20 |
| nominal OH No. of 28) | | |
| Water | 1.42 | 1.42 |
| Diethanolamine (DEOA) | 0.15 | 0.15 |
| Niax Color Stabilizer (CS-15) | 0.50 | 0.50 |
| Stannous Octoate (T-9) | 0.02 | 0.02 |
| Tertiary amine catalyst blend | 0.39 | 0.39 |
| Index | 79 | 79 |
| Lupranate ® 280 Isocyanate | 41.92 | 41.35 |
| (MDI) | | |
| Nitrogen | 2.3 | 2.3 |
| Silicone A (Niax Silicone L-635) | 0.84 | 0.37 |
| Silicone B (Niax Silicone L-626) | | 0.32 |
| Cell Opener Type 1 | 0.5 | |
| Results | | |
| Density | 3.73 | 3.56 |
| IFD 25% | 12.01 | 15.35 |
| Porosity | 0.5 | 0.25 |

As shown in Table 2, even when used at a level of 0.5 pphp, Type 1 cell opener, a polyethylene glycol monoallyl ether of 350 molecular weight, in accordance with the invention (Example 4) provided greater porosity than the foam prepared with the known silicone-type cell opener (Comparative Example 4). In addition, the IFD 25% of the foam of Example 4 decreased, a showing of foam softening, over that of foams of Comparative Example 4.

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

1. A viscoelastic polyurethane foam-forming composition which comprises:
a) at least one polyether polyol;
b) at least one organic polyisocyanate;
c) at least one catalyst for the polyurethane foam-forming reaction(s);
d) at least one silicone foam stabilizer;
e) at least one cell opener which is a polyalkylene oxide lacking silicone in its structure; and,
f) at least one blowing agent.

2. The viscoelastic polyurethane foam-forming composition of claim 1 wherein polyether polyol (a) is a mixture of at least one polyether polyol (a) (i) possessing an average molecular weight of from about 600 to about 2000 and a hydroxyl number of from about 120 to about 600 and at least one polyether polyol (a) (ii) which is a polyether polyol possessing an average molecular weight of from about 2000 to about 4000 and a hydroxyl number of from about 20 to about 120 dispersed in a dispersion of solid polymer.

3. The viscoelastic polyurethane foam-forming composition of claim 1 wherein organic polyisocyanate (b) is at least one member consisting of MDI, TDI and mixtures thereof.

4. The viscoelastic polyurethane foam-forming composition of claim 1 wherein catalyst (c) is a mixture of amine catalyst and tin-containing catalyst.

5. The viscoelastic polyurethane foam-forming composition of claim 1 wherein the silicone foam stabilizer is a silicone possessing terminal and/or internal polyether group(s).

6. The viscoelastic polyurethane foam-forming composition of claim 1 wherein polyalkylene oxide cell opener (e) possesses an ethylene oxide-based content of from about 65 to about 100 weight percent, an average hydroxyl functionality of 0 to 3 and an equivalent molecular weight of from about 200 to about 1000.

7. The viscoelastic polyurethane foam-forming composition of claim 1 wherein polyalkylene oxide cell opener is at least one member selected from the group consisting of:
polyethylene glycol monoallyl ether (CAS 27274-31-3), MW 200-1000, 100% EO (ethyleneoxide), 1 OH functionality;
polyethylene glycol allyl methyl diether (CAS 27252-80-8), MW 200-1000, 100% EO, 0 OH functionality;
polyethylene glycol monoallyl ether acetate (CAS 27252-87-5), MW 200-1000, 100% EO, 0 OH functionality;
polyethylene glycol monomethyl ether (CAS 9004-74-4), MW 200-1000, 100% EO, 1 OH functionality;
polyethylene glycol glycerol ether (CAS 31694-55-0), MW 200-1000, 100% EO, 3 OH functionality;
polyethylene-polypropylene glycol monoallyl ether (CAS 9041-33-2), MW 200-1000, 70-100% EO, 1 OH functionality;
polyethylene-polypropylene glycol monoallyl monomethyl diether (CAS 52232-27-6), MW 200-1000, 70-100% EO, 0-0.5 OH functionality; and,
polyethylene-polypropylene glycol allyl ether acetate (CAS 56090-69-8), MW 200-1000, 70-100% EO, 0 OH functionality.

8. The viscoelastic polyurethane foam-forming composition of claim 2 wherein polyalkylene oxide cell opener (e) possesses an ethylene oxide-based content of from about 65 to about 100 weight percent, an average hydroxyl functionality of 0 to 3 and an average molecular weight of from about 200 to about 1000.

9. The viscoelastic polyurethane foam-forming composition of claim 8 wherein organic polyisocyanate (b) is at least one member consisting of MDI, TDI and mixtures thereof.

10. The viscoelastic polyurethane foam-forming composition of claim 1 wherein blowing agent (f) is water.

11. The viscoelastic polyurethane foam-forming composition of claim 1 wherein organic polyisocyanate (b) is present in an amount providing an isocyanate index of below about 100, polyalkylene oxide cell opener (e) is presented at a level of from about 0.2 to about 2 pphp and blowing agent (f) is water present at a level of from about 0.5 to about 3.0 pphp.

12. The viscoelastic polyurethane foam-forming composition of claim 2 wherein first polyether polyol (a) (i) is present in the mixture at a level of from about 50 to about 95 weight percent, the balance of the mixture being made up of second polyether polyol (a) (ii).

13. The viscoelastic polyurethane foam resulting from the foaming of the foam-forming composition of claim 1.

14. The viscoelastic polyurethane foam resulting from the foaming of the foam-forming composition of claim 2.

15. The viscoelastic polyurethane foam resulting from the foaming of the foam-forming composition of claim 6.

16. The viscoelastic polyurethane foam resulting from the foaming of the foam-forming composition of claim 8.

17. The viscoelastic polyurethane foam resulting from the foaming of the foam-forming composition of claim 9.

18. A process of manufacturing a viscoelastic polyurethane foam which comprises foaming the foam-forming composition of claim 1.

19. The process of manufacturing a viscoelastic polyurethane foam which comprises foaming the foam-forming composition of claim 2.

20. The process of manufacturing a viscoelastic polyurethane foam which comprises foaming the foam-forming composition of claim 6.
